(19) United States
(12) Patent Application Publication
(10) Pub. No.: US 2012/0048839 A1
(43) Pub. Date: Mar. 1, 2012

(54) THERMAL CONTROL OF SHAPE MEMORY ALLOYS

(75) Inventors: Martin Leary, Bundoora (AU); Francesco Schiavone, Bundoora (AU); Aleksandar Subic, Bundoora (AU); Jason Miller, Port Melbourne (AU)

(73) Assignee: Co-Operative Research Centre For Advanced Automotive Technology Ltd., Port Melbourne, Victoria (AU)

(21) Appl. No.: 13/130,803

(22) PCT Filed: Nov. 23, 2009
(86) PCT No.: PCT/AU09/01520

§ 371 Date: Nov. 16, 2011

(30) Foreign Application Priority Data
Nov. 24, 2008 (AU) 2008906078

(51) Int. Cl. H05B 1/00; F28F 7/00; B32B 15/04

(52) U.S. Cl. 219/200; 428/457; 428/68; 428/448; 165/185

(57) ABSTRACT

The invention relates to shape memory alloys. In particular, the invention relates to a shape memory alloy arrangement that includes a shape memory alloy member that is configured to undergo transformation between marten site and austenite phases in response to a change in temperature of the shape memory alloy member. The arrangement also includes a heat conductive material in contact with the shape memory alloy member wherein the heat conductive material is operable for controlling the transfer of heat to or from the shape memory alloy member by conduction. The invention also relates to a shape memory alloy actuator including the shape memory alloy arrangement of the invention. The shape memory alloy arrangement is configured to be connected to a movable object and to move the object in response to a change in temperature of the shape memory alloy member.

### FIELD OF THE INVENTION

The invention relates to shape memory alloys. In particular, the invention relates to thermal control of shape memory alloys.

### BACKGROUND

Shape memory alloys (SMAS) are alloys that “remember” their geometry. An SMA can be subjected to deformation of its crystallographic configuration and subsequently reverse the deformation to its crystallographic configuration as a result of an increase in the temperature (i.e. heating) of the SMA. These properties are due to a martensitic phase transformation from a low-symmetry crystallographic structure to a highly symmetric crystallographic structure respectively known as martensite and austenite phases. Martensitic phase transformation of an SMA can be due to other factors but is mostly temperature dependant.

In the austenite phase, the SMA is hard and rigid, while in the martensite state, the SMA is softer and flexible. In the martensite state, the SMA may be stretched or deformed by an external force. Once heated, the SMA will transform to its austenite state and contract or recover any stretch that was imposed on it. The force exerted by the SMA upon contraction may be used to perform tasks such as turning a device on or off, opening or closing an object or actuating a device or object.

The three main types of SMA are copper-zinc-aluminium-nickel, copper-aluminium-nickel and nickel-titanium (NiTi) alloys. The temperatures at which the SMA changes its crystallographic structure, called transformation temperatures, are characteristic of the alloy and can be tuned by varying the elemental ratios in the alloy.

An SMA can be heated by any suitable means. One means for heating an SMA includes passing an electrical current through the alloy whereby the electrical resistance of the alloy results in the creation of heat in the alloy which in turn causes the alloy to undergo martensitic to austenitic phase transformation. After the electrical current is removed the alloy begins to cool and revert to its martensite phase structure. Thus, the heating and cooling of an SMA enables it to perform a function such as actuating an object. For example, when the SMA is heated it may actuate an object from a first position to a second position and subsequently when the SMA cools the object may move from the second position back to the first position.

The rate at which an SMA achieves martensitic phase transformation between the martensitic state and the austenite state is partially dependant on the rate at which the shape memory alloy is heated or cooled. Accordingly, the cycle time of an SMA is the time it takes for the SMA to achieve martensitic phase transformation between the martensitic state and the austenitic state and back to the martensitic state, or vice versa. The cycle time of an SMA actuator is the time it takes to actuate an object between a first position and a second position and then from the second position back to the first position. It may be desired to be able to manipulate the cycle time of an SMA and/or an SMA actuator. For example, it may be desired to have a short as possible cycle time for an SMA and/or an SMA actuator. To achieve this, it is desirable to be able to heat and/or cool the SMA as quickly as possible. The task of heating an SMA in a relatively short period can be achieved by applying a greater current through the actuator to thereby achieve a faster change in geometry of the SMA. Conversely, in order to cause the SMA to revert to the martensite state in as short a time as possible the SMA needs to be cooled in as short a time as possible.

Furthermore, there may be circumstances in which it is desirable to be able to control either the rate of increase or decrease in temperature of the SMA to thereby control the rate at which the SMA changes geometry between the austenitic state and martensitic state and in turn control the rate of movement of an object being actuated by the SMA.

### SUMMARY OF THE INVENTION

The present application is directed towards a shape memory alloy arrangement, the arrangement including:
a shape memory alloy member that is configured to undergo transformation between martensite and austenite phases in response to a change in temperature of the shape memory alloy member; and
a heat conductive material in contact with the shape memory alloy member wherein the heat conductive material is operable for transferring heat to or from the shape memory alloy member by conduction.

Heat conductivity, also known as thermal conductivity, is the property of a material that indicates its ability to conduct heat. The law of heat conduction, also known as Fourier's law, states that the time rate of heat transfer through a material is proportional to the negative gradient in the temperature and to the area at right angles, to that gradient, through which the heat is flowing. In other words, it is defined as the quantity of heat, ΔQ, transmitted during time Δt through a thickness x, in a direction normal to a surface of area A, due to a temperature difference ΔT, under steady state conditions and when the heat transfer is dependent only on the temperature gradient. Thermal conductivity is expressed in W/(m·K).

Thermal conductivity=heat flow rate×distance/(area×temperature difference):

$$k = \frac{Δ Q}{Δ t} \times \frac{L}{A \times Δ T}$$

The heat conductive material of the invention includes any material having properties whereby the majority, or substantially all, of any heat which is transferred to or from the shape memory alloy by the material as a result of contact therebetween is by way of conduction. Accordingly, the heat conductive material of the invention does not include material having properties whereby the majority, or substantially all, of any heat which is transferred to or from the shape memory alloy by the material as a result of contact therebetween is by way of convection.

Gases are generally good insulators and poor thermal conductors. The thermal conductivity of air is 0.025 W/(m·K). Gases transfer more heat by convection than by conduction. Accordingly, the heat conductive material of the invention includes materials that have a higher thermal conductivity expressed in W/(m·K) than air, that is >0.025 W/(m·K).

Non-gases such as liquids, semi-solids and solids are generally better thermal conductors than gases. The thermal conductivity of liquid water is 0.6 W/(m·K). Thermal grease (also called thermal compound, heat paste, heat transfer compound, thermal paste, or heat sink compound) is a fluid substance, with properties akin to grease, which increases the thermal conductivity of a thermal interface (by compensating for the irregular surfaces of the components). The thermal conductivity of thermal grease is 0.7-3 W/(m·K). Accordingly, the heat conductive material of the invention includes materials that have a thermal conductivity expressed in W/(m·K) of >0.6 W/(m·K) or in the range of 0.7-3 W/(m·K). The heat conductive material of the invention may also include materials that have a thermal conductivity expressed in W/(m·K) of >3 W/(m·K).

The shape memory alloy arrangement is advantageous in that as a result of contact between the heat conductive material and the shape memory alloy member cooling, heating, or both of the shape memory alloy member can be achieved more quickly compared with a material that does not conduct heat but rather transfers heat by convection such as a gas.

The shape memory alloy member has a cycle time which is dependant on the rate at which the shape memory alloy member transforms from either the martensite or austenite phases to the other one of the phases and back again. Accordingly, the fast conduction of heat to or from the shape memory alloy member by the heat conductive material of the invention enables the cycle time of the shape memory alloy member to be reduced or increased by a greater amount than would be the case if substantially all heat were transferred to or from the shape memory alloy member by a substantially non-heat conductive material. In other words, by contacting the shape memory alloy member with a heat conductive material rather than a heat insulating material the invention increases the speed with which the shape memory alloy member can be heated or cooled.

The invention is particularly advantageous because the heat conductive material facilitates a faster rate of cooling of the shape memory alloy member than a material such as air. Thus, the invention may reduce the amount of time required for the shape memory alloy member to undergo transformation from the austenite to the martensite phase as opposed to an arrangement of a shape memory alloy member which must dissipate substantially all heat, which it has gained through heating, via convection.

In one form, the shape memory alloy member has a longitudinal length and the heat conductive material covers an entire external surface of the shape memory alloy along at least a portion of the longitudinal length of the shape memory alloy member.

The shape memory alloy of claim 1 or claim 2, wherein the shape memory alloy member has a longitudinal axis along an entire length of which the longitudinal axis runs through shape memory alloy material forming the shape memory alloy member and the heat conductive material includes a longitudinal axis running in the same direction as the longitudinal axis of the shape memory alloy member.

An advantage of forms of the shape memory alloy arrangement in which the heat conductive material is in contact with an external surface of the shape memory alloy member along at least a portion of a longitudinal length of the shape memory alloy member is the increase in speed of the conduction of heat to or from the shape memory alloy member compared with a shape memory alloy member that is not in contact with a heat conductive material along at least a portion of a longitudinal length thereof. In other words, such forms of the invention increase the speed with which the shape memory alloy member can be heated or cooled.

In one form, the shape memory alloy member and the heat conductive material are arranged substantially concentrically. In another form, the shape memory alloy member and the heat conductive material are arranged substantially coaxially.

An advantage of forms of the shape memory alloy arrangement in which the shape memory alloy member and the heat conductive material are arranged concentrically and/or coaxially is that the entire external surface area of the shape memory alloy member along a portion of the longitudinal length thereof is in contact with the heat conductive material thereby further enhancing the speed of the conduction of heat to or from the shape memory alloy member.

In yet another form, the arrangement further includes means for controlling the heat conductivity of the heat conductive material to control the transfer of heat to or from the shape memory alloy member by conduction. Thermal conductivity depends on many properties of a material, notably its structure and temperature. Accordingly, by providing means for altering the structure or temperature of the heat conductive material the heat conductivity of the heat conductive material can be altered.

In one form of the shape memory alloy arrangement, the heat conductive material is operable for controlling the rate at which the shape memory alloy member undergoes transformation between the martensite and austenite phases.

In another form, the heat conductive material is operable for controlling a cycle time for the shape memory alloy. This form of the shape memory alloy arrangement is advantageous in that when incorporated in a shape memory alloy actuator the cycle time of the actuator is also controllable. The cycle time for the shape memory alloy may include the rate at which the shape memory alloy member transforms from either the martensite or austenite phases to the other one of the phase and back again.

In yet another form, the shape memory alloy arrangement further includes a cover at least partially surrounding the heat conductive material and the shape memory alloy member. In arrangements in which the heat conductive material is in a non-solid form an advantage of the cover is that it can assist in retaining the heat conductive material in contact with the shape memory alloy member. Another advantage of the cover is that, whether the heat conductive material is a solid, semi-solid, viscous material, paste or a low viscosity liquid, the cover may protect the heat conductive material from damage, contamination, abrasion and the like.

The shape memory alloy of claim 12, wherein the shape memory alloy member has a longitudinal axis along an entire length of which the longitudinal axis runs through shape memory alloy material forming the shape memory alloy member and the cover includes a longitudinal axis running in the same direction as the longitudinal axis of the shape memory alloy member.

The cover may be configured so that when the shape memory alloy member changes shape during transformation between the martensite or austenite phases in response to a change in temperature the cover also changes shape.

The cover may be formed out of a flexible material and/or a resilient material.

By providing a cover which is flexible and/or resilient the cover does not impede the change in geometry of the shape memory alloy member upon heating and/or cooling thereof.

In one form, the shape memory alloy member and the cover are arranged substantially concentrically.

In another form, the shape memory alloy member and the cover are arranged substantially coaxially.

In one form, the shape memory alloy member has a longitudinal length, the heat conductive material covers an entire external surface of the shape memory alloy member along at least a portion of the longitudinal length and the cover surrounds the heat conductive material and the shape memory alloy member along the portion of the length of the shape memory alloy member covered by the heat conductive material.

In one form, the heat conductivity of the heat conductive material is controllable for controlling the transfer of heat to or from the shape memory alloy member by conduction.

In another form, the arrangement further includes means for controlling the temperature of the heat conductive material to thereby control the rate of conduction of heat to or from the shape memory alloy member.

In one form, the shape memory alloy arrangement further includes a heat transfer device for transferring heat to or from the heat conductive material and thereby controlling the temperature of the heat conductive material.

In one form, the heat conductive material is a fluid, a solid or a semi-solid material. The heat conductive material may be formed out of any one or more of a group including glycol, silicon paste and oil.

In another form, the arrangement further includes means for facilitating the change in temperature of the shape memory alloy member. The means for facilitating the change in temperature of the shape memory alloy member includes means for applying an electrical current to the shape memory alloy member.

In another aspect, the present invention may provide a shape memory alloy actuator including a shape memory alloy arrangement according to any one of the preceding claims, wherein the shape memory alloy arrangement is configured to be connected to a movable object and to move the object in response to a change in temperature of the shape memory alloy member.

Further aspects and concepts will become apparent to those skilled in the art after considering the following description and claims in conjunction with the accompanying drawings.

### BRIEF DESCRIPTION OF THE DRAWINGS

in the accompanying drawings, which are incorporated in and constitute a part of the specification, embodiments of the invention are illustrated, which, together with a general description of the invention given above, and the detailed description below, serve to exemplify embodiments of the invention;

FIG. 1 is a perspective view of an SMA member that is concentrically surrounded by both a heat conductive material and a cover wherein the cover retains the heat conductive material in contact with the shape memory alloy member.

FIG. 2 is an end view of a transverse cross-section of the shape memory alloy actuator of FIG. 1.

FIG. 3 is a side view of a longitudinal cross-section of the shape memory alloy actuator of FIG. 1 wherein the shape memory alloy is in the martensitic state and is stretched into a relatively longer geometry.

FIG. 4 is a side view of a longitudinal cross-section of the shape memory alloy actuator of FIG. 1 in which the shape memory alloy is in austenitic state as a result of heating of the shape memory alloy member wherein the shape memory alloy member is contracted into a relatively shorter geometry.

FIG. 5 illustrates a perspective view of another form of the shape memory alloy actuator wherein the actuator further includes a heat transfer device for transferring heat to or from the heat conductive material.

FIG. 6 illustrates a perspective view of another form of shape memory alloy actuator wherein the actuator includes a plurality of the shape memory alloy members that are each respectively surrounded by both heat conductive material and a cover and that are interwoven.

### DETAILED DESCRIPTION

The present application discloses a shape memory alloy (SMA) arrangement and an actuator incorporating the shape memory alloy arrangement. The arrangement and the actuator may take any suitable form and be used for any suitable purpose. The arrangement and the actuator may perform any suitable tasks such as turning a device on or off, opening or closing an object or actuating a device or object. The SMA actuator may be operatively associated with a wide variety of actuatable devices in a wide variety of applications including (but not limited to) motor vehicle, aerospace, military, medical, safety and robotics applications.

Although the following detailed description relates to an actuator incorporating the SMA arrangement of the invention it is to be appreciated that the invention may have broader application than in relation to actuators. For example, the SMA arrangement of the invention may have application where the properties of SMA alloys, namely its ability to change its geometry or shape in response to a change in its temperature, make the use of an SMA alloy member suitable.

One of the principals of action of the SMA arrangements and actuators of the invention disclosed herein is that they include an SMA member that is in contact with and surrounded by a heat conductive material which, in one form, facilitates conducting heat from the SMA member after an electrical current applied to the SMA member, which has resulted in heating the SMA member, has been removed. By conducting heat from the SMA member the heat conductive material facilitates a reduction in temperature of the SMA member at a greater rate than would be possible if the SMA member was surrounded by air and required to dissipate heat by convection.

The heat conductive material of the invention includes any material having properties whereby the majority, or substantially all, of any heat which is transferred to or from the shape memory alloy by the material as a result of contact therebetween is by way of conduction. Accordingly, the heat conductive material of the invention does not include material having properties whereby the majority, or substantially all, of any heat which is transferred to or from the shape memory alloy by the material as a result of contact therebetween is by way of convection.

Gases are generally good insulators and poor thermal conductors. The thermal conductivity of air is 0.025 W/(m·K). Gases transfer more heat by convection than by conduction. Accordingly, the heat conductive material of the invention includes materials that have a higher thermal conductivity expressed in W/(m·K) than air, that is >0.025 W/(m·K) and preferably materials having a thermal conductivity of air.

In some forms, the heat conductive material is maintained in contact with the SMA member by a cover which surrounds both the SMA member and the heat conductive material. As a result, the SMA member is immersed in the heat conductive material which may in turn be surrounded by the cover. In one form, the cover is a flexible material which enables it to move along with the SMA member.

Thus, the SMA actuator can achieve faster or slower rates of cooling, or heating, or both as a result of the application of a heat conductive material around the SMA member and, optionally, a cover surrounding both the SMA member and heat conductive material. Accordingly, the cycle time of the SMA actuator can be reduced or increased by enabling the SMA member to be cooled or heated at a faster rate than by convection without a heat conductive material in contact with the SMA member. Furthermore, in the forms of the SMA actuator illustrated herein the heat conductive material is in contact with an external surface of the SMA member along at least a portion of a longitudinal length of the SMA member. More particularly, the heat conductive material is in contact with substantially the entire exterior surface of the SMA member, along at least a portion of its length, to facilitate as fast as possible speed of conduction of heat to or from the SMA member as is possible given the magnitude of heat conductivity of the heat conductive material. For example, the SMA member and the heat conductive material, and optionally also the cover, are concentrically and/or coaxially arranged. Furthermore, by providing a cover which is flexible and/or resilient the cover does not impede the change in geometry of the SMA member upon heating and/or cooling thereof.

Referring to FIGS. 1 to 5, there is shown an SMA actuator 10. The SMA actuator 10 includes an SMA member 20 which, in embodiments illustrated, is an elongate and substantially linear SMA member 20. However, it is to be appreciated that the SMA member 20 may take any other suitable form or configuration. For example, the SMA member 20 may be in the form of a coil such as a spring, a helical configuration, a non-linear elongate member such as a bent elongate member or a curved elongate member or an elongate member including a number of bends or curves. In each form the SMA member 20 has a longitudinal axis X. Along an entire length of the SMA member 20 the longitudinal axis X runs through shape memory alloy material forming the shape memory alloy member 20. As shown in FIG. 1, the longitudinal axis X is an imaginary line running through the centre of the material forming the SMA member. In other words, the SMA member 20 is solid through the longitudinal axis X along the entire length of the longitudinal axis X. Thus, the SMA member 20 and the longitudinal axis X run in the same direction along their entire lengths. Furthermore, the SMA member 20 illustrated in the Figures has a substantially uniform cross-section. However, the SMA 20 may have varying cross-sections throughout and may have a variable and/or tapering profile such that at parts of the SMA member 20 are substantially thinner than other parts which are substantially thicker.

The SMA member 20 may be made of any material that is capable of changing its geometry as a result of heating or cooling. The SMA member 20 may be made of copper-zinc-aluminium, copper-zinc-aluminium-nickel, copper-aluminium-nickel, silver-cadmium, gold-cadmium, copper-tin, copper-zinc, indium-titanium, nickel-aluminium, iron-platinum, manganese-copper, iron-manganese-sillicon or nickel-titanium (NiTi) alloys. Such alloys may have an austenite state or phase and a martensite state or phase. Accordingly, during heating Aₛ and A_{f} are the temperatures at which the transformation from martensite to austenite starts and finishes. Mₛ denotes the temperature at which the SMA generally starts to change from austenite to martensite upon cooling. M_{f} is the temperature at which the transition to martensite is finished during cooling. The transition of the SMA member 20 between the martensite and austenite phases is dependant on temperature. Furthermore, the rate at which the SMA member 20 transitions between the martensite and austenite phases is dependant on the rate at which the SMA member 20 increases or decreases in temperature.

The SMA member 20 includes an exterior surface 22 which faces radially outwardly around the circumference of the SMA member 20 and/or which extends along the substantially entire length of the SMA member 20. As such, the exterior surface 22 of the SMA member 20 may present substantially the entirety of any exposed surface of the SMA member 20. Another form of the SMA member (not shown) may be in the form of a hollow elongate member which has an opening or hollow extending longitudinally through the SMA member along part of or the entire length of the SMA member in combination with any of the other configurations described and illustrated herein. In the case of the SMA member being a hollow elongate member the longitudinal axis X is not central to the SMA member. However, the longitudinal axis X runs through the material forming the SMA member along the entire length of the SMA member and along the entire length of the longitudinal axis X. In other words, even the hollow version of the SMA member is solid through the longitudinal axis X along the length of the longitudinal axis X. Also, in the hollow SMA member the exterior surface 22 may also include a surface (not shown) which faces radially inwardly towards the opening or hollow extending centrally and longitudinally through the middle of the SMA member.

Referring to FIGS. 1 to 5, the SMA member 20 is surrounded by a layer of heat conductive material 30 The SMA member 20 and the heat conductive material 30 both share substantially the same longitudinal axis X. That means, the heat conductive material 30 surrounds the SMA member 20 along the longitudinal axis X of the SMA member 20. In other words, the heat conductive material 30 surrounds the SMA member 20 along the longitudinal axis X which runs through substantially the centre of the material forming the SMA member 20 along substantially the length of the SMA member 20. Put another way, the SMA member 20 is covered by the heat conductive material 30 along the longitudinal length of the SMA member 20. Thus, the SMA member 20 and the heat conductive material 30 run in the same direction along the longitudinal axis X. Also, the SMA member 20 and the heat conductive material 30 are substantially concentric. In the embodiment illustrated in FIGS. 1 to 5 the SMA member 20 and the heat conductive material 30 are also both substantially coaxial.

The heat conductive material 30 has an outer surface 32 and an opposite inner surface 34. The inner surface 34 faces radially inwardly towards, and is in face to face contact with, the exterior surface 22 of the SMA member 20. The heat conductive material 30 may cover the exterior surface 22 of the SMA 20 member along at least a portion of a longitudinal length of the SMA member 20. Alternatively, the heat conductive material 30 may cover substantially the entire exterior surface 22 along a portion of the length of the SMA member 20 or along substantially the entire length of the SMA member 20. Thus, the heat conductive material 30 may extend around the entire circumference of the SMA member 20 along substantially the entire length or a portion of the length of the SMA member 20. Accordingly, there may essentially be no part of the SMA member 20 along its entire length or a portion of its length which is not in contact with the heat conductive material 30. Where the SMA member 20 is in the form of a hollow elongate member the hollow interior (not shown) provides a space in which the heat conductive material 30 can be placed in the manner and for the purpose which is described herein, namely to transfer heat to or from the SMA member 20 by way of conduction. In this arrangement (not shown), the outer surface 32 of the heat conductive material 30 faces radially outwardly towards, and is in face to face contact with, the radially inwardly facing portion of the exterior surface 22 of the SMA member 20.

The heat conductive material 30 may be formed out of any material fitting the requirements set out herein. Non-gases such as liquids, semi-solids and solids are generally better thermal conductors than gases. The thermal conductivity of liquid water is 0.6 W/(m·K). Thermal grease (also called thermal compound, heat paste, heat transfer compound, thermal paste, or heat sink compound) is a fluid substance, with properties akin to grease, which increases the thermal conductivity of a thermal interface (by compensating for the irregular surfaces of the components). The thermal conductivity of thermal grease is 0.7-3 W/(m·K). Accordingly, the heat conductive material of the invention includes materials that have a higher thermal conductivity expressed in W/(m·K) than air, that is >0.025 W/(m·K) and preferably materials having a thermal conductivity of thermal grease, that is 0.7-3 W/(m·K). Accordingly, the heat conductive material of the invention preferably includes materials that have a thermal conductivity expressed in W/(m·K) of >0.6 W/(m·K) or in the range of 0.7-3 W/(m·K). The heat conductive material of the invention may also include materials that have a thermal conductivity expressed in W/(m·K) of >3 W/(m·K).

The heat conductive material 30 is preferably formed out of a material that is adapted to conduct heat from the exterior surface 22 of the SMA member 20. Accordingly, the heat conductive material 30 may be formed out of a fluid which may include any one or more of the group including glycol, silicon paste and oil and may be any viscous, semi-viscous or non-viscous liquid. Alternatively, the heat conductive material 30 may be a gel or semi-solid material. However, the heat conductive material 30 should have a degree of flexibility or malleability in order that the shape and configuration of the heat conductive material 30 may change along with any change in the geometry of the SMA member 20 while still maintaining contact between the inner surface 34 of the heat conductive material 30 and the exterior surface 22 of the SMA member 20.

Referring to FIGS. 1 to 5, the SMA actuator 10 further includes a cover 40 which surrounds and/or contains the heat conductive material 30. The cover 40 may be formed out of an electrically insulating material. Because the heat conductive material 30 may be a fluid or a non-solid material the cover 40 functions to maintain the heat conductive material 30 in contact with the exterior surface 22 of the SMA member 20. The cover 40 has an inner surface 44 and an opposite exterior surface 42. The inner surface 44 of the cover 40 faces radially inwardly and defines a passage 45 extending longitudinally within the cover 40. The heat conductive material 30 and the SMA member 20 are positioned within the longitudinal passage 45 of the cover 40. The inner surface 44 of the cover 40 is in face to face contact with the exterior surface 32 of the heat conductive material 30. The inner surface 44 of the cover 40 may be substantially impenetrable to the material which forms the heat conductive material 30. Thus, the cover 40 can ensure that the heat conductive material 30 is maintained between the inner surface 44 of the cover 40 and the exterior surface 22 of the SMA member 20 and cannot escape the space between the inner surface 44 and the cover 40 and the exterior surface 22 of the SMA member 20.

The SMA member 20, the heat conductive material 30 and the cover 40 all share substantially the same longitudinal axis X. That means, the cover 40 surrounds the heat conductive material 30, which in turn surrounds the SMA member 20, along the longitudinal axis X of the SMA member 20. In other words, the cover 40 surrounds the heat conductive material 30, which in turn surrounds the SMA member 20, along the longitudinal axis X which runs through substantially the centre of the material forming the SMA member 20 along substantially the length of the SMA member 20. Put another way, the SMA member 20 is covered by the heat conductive material 30 along the longitudinal length of the SMA member 20. Thus, the cover 40, the SMA member 20 and the heat conductive material 30 run in the same direction along the longitudinal axis X. Also, the cover 40, the SMA member 20 and the heat conductive material 30 are substantially concentric. In the embodiment illustrated in FIGS. 1 to 5 the cover 40, the SMA member 20 and the heat conductive material 30 are also substantially coaxial.

The material forming the cover 40 may be a flexible material such that if and when the geometry of the SMA member 20 changes, which in turn may cause the shape and configuration of the heat conductive material 30 surrounding the SMA member 20 to also change, the cover 40 which contains the heat conductive material 30 can also change in shape and configuration to accommodate a changing shape and configuration of the heat conductive material 30 and/or the SMA member 20.

The material forming the cover 40 may be resilient such that when the shape and configuration of the cover 40 is altered temporarily as a result of the change in geometry of the SMA member 20 and any associated change in shape and configuration of the heat conductive material 30 the cover 40 can return to its initial shape and configuration after the SMA member 20 and/or the heat conductive material 30 have reverted back to their initial geometry. The flexible and/or resilient nature of the cover 40 can help ensure that the shape and configuration of the heat conductive material 30 also reverts to its initial shape and configuration after the SMA member 20 reverts to its initial geometry. Thus, the flexible and/or resilient properties of the cover 40 enable it to ensure that the inner surface 34 of heat conductive material 30 is maintained in contact with substantially the entire exterior surface 22 of the SMA member 20 along the entire length or a portion of the length of the SMA member 20.

In another form, the material forming the cover 40 may be a rigid non-flexible material. The shape of the rigid cover 40 may be such that if and when the geometry of the SMA member 20 changes the SMA member 20 may slide longitudinally within the passage 45 within the heat conductive material 30 within the cover 40. In this form, even though the cover 40 is formed out of a rigid material it does not substantially impede the change in geometry of the SMA member 20 or any change in shape or configuration of the heat conductive material 30 surrounding the SMA member 20.

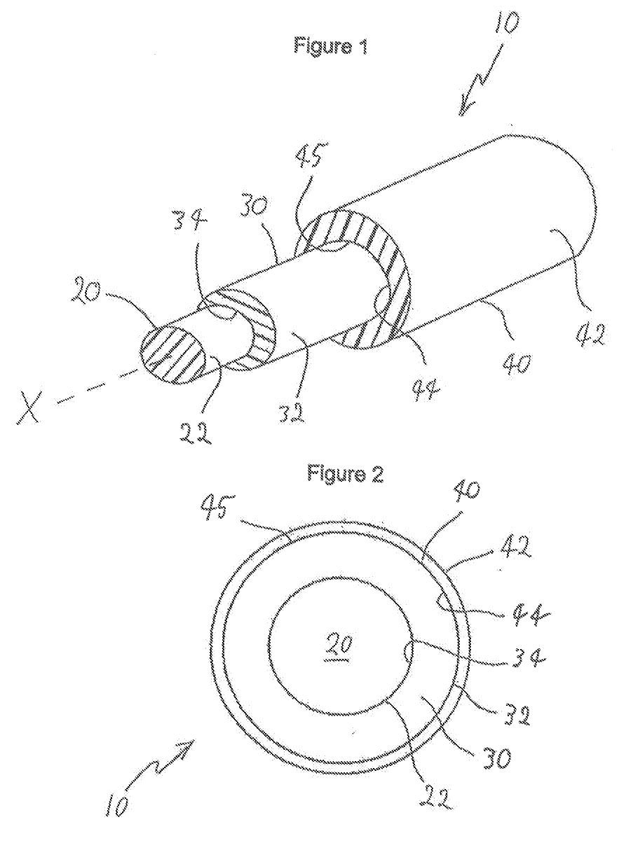

For example, in the embodiment illustrated in FIGS. 1 and 2, the cover 40 and the SMA member 20 are both substantially coaxial which means that the cover 40 can be formed out of a rigid material and the SMA member 20 can change in longitudinal length in response to a change in the temperature thereof by moving longitudinally within the longitudinal passage 45 defined within the inner surface 44 of the cover 40. However, it is to be appreciated that the cover 40 need not necessarily be coaxial with the SMA member 20 and/or the heat conductive material 30 to allow movement of the SMA member 20 relative to the rigid cover 40 in response to a change in temperature of the SMA member 20 but may have any other suitable shape or configuration. For example, the SMA member 20 may be positioned eccentrically within the cover 40 and/or the heat conductive material 30. Thus, the central axis X of the SMA member 20 may run parallel and in the same direction to a central axis of the cover 40 and/or a central axis of the heat conductive material 30.

In the forms of the SMA actuator 10 illustrated herein the heat conductive material 30 is in contact with substantially the entire exterior surface 22 of the SMA member 20, along at least a portion of a longitudinal length of the SMA member 20. This facilitates as fast a rate of conduction of heat to or from the SMA member 20 as is possible given the magnitude of heat conductivity of the heat conductive material. As can be seen in FIGS. 1 to 5, the SMA member 20, the heat conductive material 30 and the cover 40 are concentrically and/or coaxially arranged.

The material which forms the cover 40 may include suitable flexible, resilient, non-flexible or rigid material and may such as any one or more of the materials including but not limited to plastics, elastomer, nylon, thermoplastic, thermo-sets, metal, aluminium, steel.

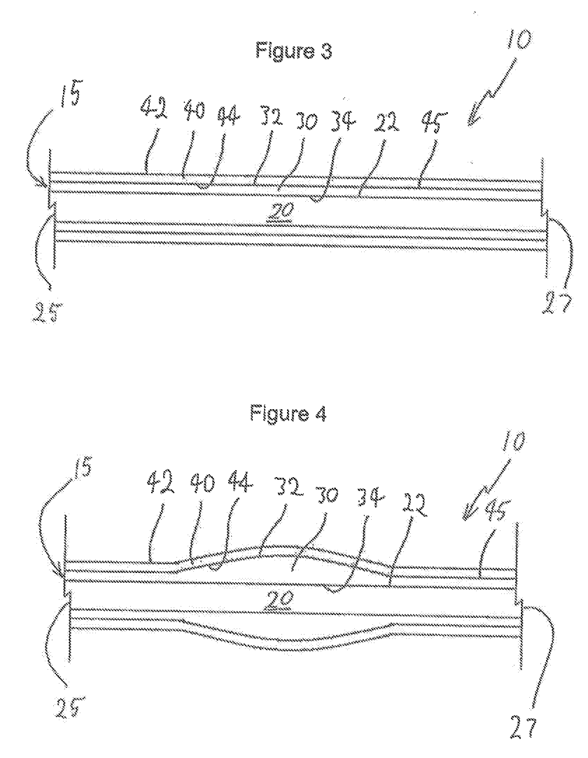

Referring to FIGS. 3 and 4, the SMA actuator 10 is shown in use. The SMA actuator 10 has a first end 15 and a second end 17. At the first end 15 of the SMA actuator 10 the SMA member 20 also has a first end 25 whilst at the second end 17 of the SMA actuator 10 the SMA member 20 has a second end 27. A current may be applied to the SMA member 20 by attaching an electrode (not shown) at the first end 25 and another electrode (not shown) at the second end 27 and passing an electrical current between the electrodes and through the SMA member 20. As a result of an electrical current being passed through the SMA member 20 the electrical resistance of the material forming the SMA member 20 results in the generation of heat within the SMA member 20. Accordingly, the SMA member 20 is heated from the Aₛ temperature to the A_{f} temperature and its geometry transitions between the martensite phase to the austenite phase. In the transition from the martensite phase to the austenite phase the SMA member 20 contracts to the length as illustrated in FIG. 4.

Accordingly, prior to contraction the SMA member 20 can assume an extended geometry when the material forming the SMA member 20 is in the martensite state in which the alloy is softer and flexible as illustrated in FIG. 3. The SMA member 20 may be stretched or elongated to a relatively longer length as illustrated in FIG. 3 by the application of an external force such as by a biasing means such as a spring or some other force applied to the first end 25 and the second end 27 in a direction away from each other. Thus, when the SMA member 20 is in the martensite state the temperature of the SMA member 20 is relatively low at temperature Aₛ and/or M_{f}. When the current is passed through the SMA member 20 it begins to heat and approach a higher temperature A_{f} and contract as illustrated in FIG. 4. The first end 25 of the SMA member 20 may be connected to an object (not shown) and the second end 27 of the SMA member 20 may be connected to another object (not shown) such that the contraction and change in length of the SMA member 20 results in a relative movement of the objects attached to the first end 25 and the second end 27 of the SMA member 20 and thereby provide actuation thereof.

After the current applied to the SMA member 20 is stopped the SMA member 20 begins to dissipate heat that has been generated as a result of the current passing through the SMA member 20. As the SMA member 20 dissipates heat its temperature changes from Mₛ to M_{f} at which the transformation from the austenite to martensite phases start and finish as illustrated in FIG. 3. As a result of transforming from the martensite to the austenite phases the geometry of the SMA member 20 alters such that the length of the SMA member 20 extends either by its own or by the application of an external force which stretches the SMA member 20. The rate at which the SMA member 20 transitions from the martensite to the austenite phases depends on the rate at which the heat within the SMA member 20 can be dissipated. The heat conductive material 30 conducts heat away from the SMA member 20 much more rapidly than would be the case if the SMA member 20 were simply surround by air or by some other material that is not specifically adapted to conduct heat but rather is considered an insulator of heat. By providing the heat conductive material 30 the rate at which the heat is conducted from the SMA member 20 is increased. Thus the heat conductive material 30 speeds up the transition of the SMA member 20 from the martensite to the austenite phases and in turn speeds up the transition from the contracted length illustrated in FIG. 4 to the extended length illustrated in FIG. 3. Accordingly, the SMA member 20 and the SMA actuator 10 is more quickly returned to the austenite phase at which the SMA member 20 and the SMA actuator 10 is ready to be transitioned again from the austenite to the martensite phase upon the application of heat to the SMA member 20 such as by the application of a current there through. Accordingly, the heat conductive material 30 facilitates a faster cycle time for the SMA member 20 and the SMA actuator 10 which enables the SMA member 20 and the SMA actuator 10 to actuate objects relative to each other that are attached to the first end 25 and the second end 27 of the SMA member 20 on a greater number of occasions over a given period of time.

As can be seen in the embodiment of FIG. 4, when the SMA member 20 transitions between the martensite and austenite phases and the length of the SMA member 20 contracts the heat conductive material 30 which surrounds the SMA member 20 collects and protrudes radially outwardly from the exterior surface 22 of the SMA member 20 to form a bulge. The flexible and/or resilient nature of the cover 40 which surrounds the heat conductive material 30 facilitates the bulging of the heat conductive material 30 by stretching radially outwardly from the SMA member 20. When the SMA member 20 transitions from the austenite to the martensite phase and the SMA member 20 stretches out as illustrated in FIG. 3 the heat conductive material 30 surrounding the SMA member 20 stretches out to its initial shape and configuration and the cover 40 which surrounds the heat conductive material 30 also returns to its initial shape and configuration. The cover 40 may return to its initial configuration by virtue of its flexible and/or resilient properties. Thus, the cover 40 may contract radially inwardly towards the SMA member 20 to its initial shape and configuration and thereby maintain the heat conductive material 30 in face to face contact with the exterior surface 22 of the SMA member 20 ready for another transition of the SMA member 20 from the martensite to austenite phases.

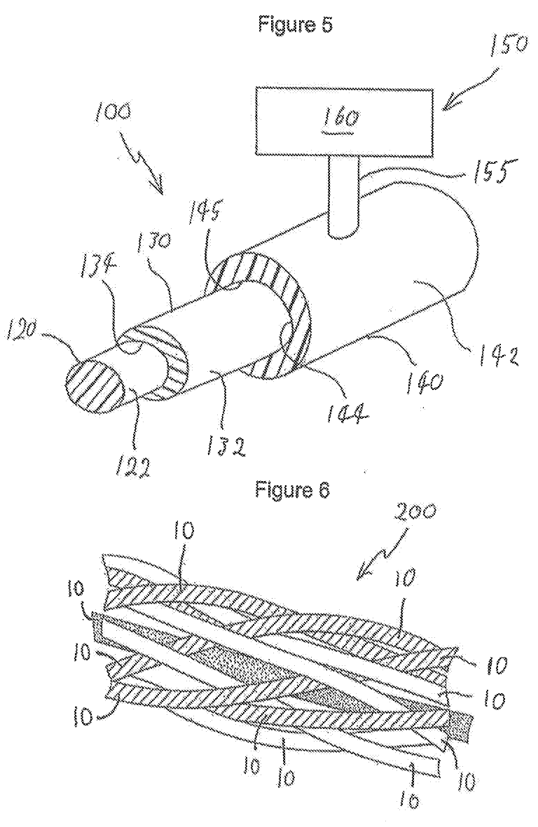

Referring to FIG. 5, there is shown another form of an SMA actuator 100 which also includes an SMA member 120, a heat conductive member 130 which surrounds the SMA member 120 and a cover 140 which surrounds the heat conductive material 130 and which maintains the heat conductive material 130 in face to face contact with the exterior surface 122 of the SMA member 120. However, in contrast to the SMA actuator 10 illustrated in FIGS. 1 to 4, the SMA actuator 100 illustrated in FIG. 5 also includes a means for controlling the temperature of the heat conductive material 130 to thereby control of the rate of conduction of heat to or from the shape memory alloy member 120. The means for controlling the temperature of the heat conductive material 130 includes a heat transfer device 150. The heat transfer device 150 is any suitable form of heat transfer apparatus and may be an apparatus which serves to provide cooling or heating or both. The heat transfer device 150 includes a connection which facilitates the passage of heat conductive material 30 from the space between the cover 140 and the SMA member 120 to a heat transfer system 160. Once the heat conductive material 130 has passed through the connection 155 to the heat transfer system 160, the heat conductive material 130 can be heated or cooled as required and then can pass back through the connection 155 to the space between the cover 140 and the SMA member 120. Thus, by facilitating the ability to heat or cool the heat conductive material 130 the heat transfer device 150 can enable the manipulation of the rate at which the heat conductive material 130 conducts heat to and/or from the SMA member 120 to thereby manipulate the rate at which the SMA member 120 transitions between the martensite and the austenite phases and vice versa which in turn facilitates manipulation of the rate at which the SMA member 120 contracts and/or can be extended. Accordingly, the heat transfer device 150 can also facilitate manipulation of the cycle time of the SMA member 120 and the SMA actuator 100.

Alternatively, the heat conductive material 130 may not pass through the connection 155 to the heat transfer system 160 but rather the heat transfer system 160 and the connection 155 may otherwise facilitate a transfer of heat between heat conductive material 130 and the heat transfer system 160 to heat or cool the heat conductive material 130. For example, the heat transfer device 150 may include one or more passages (not shown) extending between the heat transfer system 160 and the heat conductive material 130 via the connection 155 wherein the passages are configured to enable a fluid such as a coolant to transfer heat between the heat transfer system 160 and the heat conductive material 130. Accordingly, the passages may not provide fluid communication between the heat transfer system 160 and the heat conductive material 130 but rather the heat transfer device 150 is a closed system for transferring heat between the heat transfer system 160 and the heat conductive material 130.

Referring to FIG. 6, there is shown an SMA actuator 200 which is formed out of a plurality of SMA actuators 10 which are interwoven or otherwise meshed with each other. Each of the SMA actuators 10 substantially corresponds to the SMA actuator 10 illustrated in FIGS. 1 to 4 or substantially corresponds to the SMA actuator 100 illustrated in FIG. 5. Thus, each of the SMA actuators 10 of the woven length of the SMA actuator 200 illustrated in FIG. 6 includes an elongate SMA member 20 surrounded by a heat conductive material 30 which is in face to face contact with substantially the entire exterior surface 22 of the SMA member 20 and a cover 40 which surrounds the heat conductive material 30 and maintains the heat conductive material 30 in face to face contact with the exterior surface 22 of the SMA member 20. Furthermore, each of the SMA members 20 includes a first end 25 and a second end 27 which are connected to one or more objects (not shown). Furthermore, each SMA member 20 can be heated by any suitable means such as by the application of an electrical current through each of the SMA members 20 which results in heating each of the SMA members 20 from the temperature Aₛ to the temperature A_{f} at which each of the SMA members 20 transitions from the martensite to the austenite phases. Conversely, each of the SMA members 20, after the removal of the current, begins to dissipate heat which is conducted from the SMA members 20 by the heat conductive material 30 such that each of the SMA members 20 cools from the temperature Mₛ to the M_{f} which corresponds to the transition from the austenite to the martensite phases and which facilitates extension of the SMA members 20.

By surrounding each of the SMA members 20 with a heat conductive material 30 and a cover 40 wherein the heat conductive material 30 and/or the cover 40 are insulators and are therefore non-electrically conductive materials then each of the SMA members 20 of the SMA actuators 10 within the woven length of SMA actuators 200 is electrically insulated from each other and will not result in short circuiting or other electrical interference therebetween. Accordingly, the configuration of the SMA actuator 10 enables a plurality of the SMA actuators 10 to be configured in close contact or in actual contact with each other without concern for the possibility that each of the SMA actuators 10 may short circuit or otherwise electrically interfere with each other.

Although the SMA actuators 10, 100, 200 disclosed herein are disclosed in the context of substantially linear actuators with substantially linear SMA members 20, 120, it is to be appreciated that such SMA actuators 10, 100, 200 and their associated SMA members 10, 120 need not necessarily be linear. Rather, they can be in the form of a coil such as a spring, a helical configuration, a non-linear elongate member such as a bent member, a curved member, a turned member, a folded member, a curled member, a twisted member or a member including a number of bends, curves, folds, curls or twists or combinations thereof. Accordingly, in some non-linear configurations of the SMA actuators 10, 100, 200 and SMA members 20, 120 the transition thereof between the martensite and austenite phases during heating may not necessarily result in a contraction of the length of the SMA members 20, 120. Instead, the transition of the SMA members 20, 120 between the martensite and austenite phases either during heating from Aₛ to A_{f} or cooling from Mₛ to M_{f} may result in a change in geometry which involves a bending, straightening, turning, folding, unfolding, curling, uncurling, twisting, untwisting or any other change in geometry which is dependant upon the formation which is given to the SMA members 20, 120.

Furthermore, although the SMA actuators 10, 100, 200 disclosed herein are disclosed in the context of substantially linear wire actuators with substantially linear wire SMA members 20, 120, it is to be appreciated that such SMA actuators 10, 100, 200 and their associated SMA members 10, 120 need not necessarily be formed out of a wire or in a wire shape but could be planar, flat, hollow, tubular, thick, thin, woven etc.

Furthermore, although the SMA members 10, 120 and the SMA actuators 10, 100, 200 disclosed herein are disclosed in the context of elongate arrangements having substantially circular cross-sections it is to be appreciated that such SMA members 10, 120 and SMA actuators 10, 100, 200 need not necessarily have such circular cross-sections. On the contrary, the SMA members 10, 120 and the SMA actuators 10, 100, 200 could have any cross-sectional shape including but not limited to an elliptical, triangular, square, parallelogram, pentagonal, hexagonal, octagonal etc. cross-sectional shape. Similarly, the cross-sectional shape of the heat conductive material 30, 130 and/or the cover 40, 140 may also be circular or any other shape including but not limited to elliptical, triangular, square, parallelogram, pentagonal, hexagonal, octagonal etc.

The shape of the cover 40, 140 may be such as to form a plurality of fins or ribs (not shown). The fins or ribs can be arranged transversely to the longitudinal axis X of the SMA member 20, 120 such that each fin or rib forms a ring that is substantially concentric about the SMA member 20, 120. In another form, fins or ribs may be arranged longitudinally in the same direction as the longitudinal axis X such that each fin or rib runs in substantially the same direction as the SMA member 20, 120. By including fins or ribs the surface area of the cover 40, 140, and the surface area of the heat conductive material 30, 130 contained within the cover, is increased. Thus, the capacity of the cover 40, 140 and/or the heat conductive material 30, 130 to dissipate heat is increased.

The invention has been described herein with reference to preferred embodiments. Modification and alterations may occur to persons skilled in the art upon reading and understanding this specification. It is intended to include all such modifications and alterations in so far as they fall within the scope of the following claims or equivalents thereof.

1. A shape memory alloy arrangement, the arrangement including:
a shape memory alloy member that is configured to undergo transformation between martensite and austenite phases in response to a change in temperature of the shape memory alloy member; and
a heat conductive material in contact with the shape memory alloy member wherein the heat conductive material is operable for controlling the transfer of heat to or from the shape memory alloy member by conduction.

2. The shape memory alloy arrangement of claim 1, wherein the shape memory alloy member has a longitudinal length and the heat conductive material covers an entire external surface of the shape memory alloy member along at least a portion of the longitudinal length of the shape memory alloy member.

3. The shape memory alloy of claim 1 or claim 2, wherein the shape memory alloy member has a longitudinal axis along an entire length of which the longitudinal axis runs through shape memory alloy material forming the shape memory alloy member and the heat conductive material includes a longitudinal axis running in the same direction as the longitudinal axis of the shape memory alloy member.

4. The shape memory alloy arrangement of any one of the preceding claims, wherein the shape memory alloy and the heat conductive material are arranged substantially concentrically.

5. The shape memory alloy arrangement of any one of the preceding claims, wherein the shape memory alloy and the heat conductive material are arranged substantially coaxially.

6. The shape memory alloy arrangement of any one of the preceding claims, further including means for controlling the heat conductivity of the heat conductive material to control the transfer of heat to or from the shape memory alloy member by conduction.

7. The shape memory alloy arrangement of any one of the preceding claims, further including means for controlling the temperature of the heat conductive material to thereby control of the rate of conduction of heat to or from the shape memory alloy member.

8. The shape memory alloy arrangement of any one of the preceding claims, further including a heat transfer device for transferring heat to or from the heat conductive material and thereby controlling the temperature of the heat conductive material.

9. The shape memory alloy arrangement of any one of the preceding claims, wherein the heat conductive material is a fluid, a solid or a semi-solid material.

10. The shape memory alloy arrangement of any one of the preceding claims, wherein the heat conductive material is formed out of any one or more of a group including glycol, silicon paste and oil.

11. The shape memory alloy arrangement of any one of the preceding claims, wherein the heat conductive material is operable for controlling a cycle time for the shape memory alloy, wherein the cycle time for the shape memory alloy includes the rate at which the shape memory alloy member transforms from either the martensite or austenite phases to the other one of the phase and back again.

12. The shape memory alloy arrangement of any one of the preceding claims, wherein the shape memory alloy arrangement further includes a cover at least partially surrounding the heat conductive material and the shape memory alloy member.

13. The shape memory alloy of claim 12, wherein the shape memory alloy member has a longitudinal axis along an entire length of which the longitudinal axis runs through shape memory alloy material forming the shape memory alloy member and the cover includes a longitudinal axis running in the same direction as the longitudinal axis of the shape memory alloy member.

14. The shape memory alloy arrangement of claim 12 or claim 13, wherein the cover is configured so that when the shape memory alloy member changes shape during transformation between the martensite or austenite phases in response to a change in temperature the cover also changes shape.

15. The shape memory alloy arrangement of any one of claims 12 to 14, wherein the cover is formed out of a flexible material.

16. The shape memory alloy arrangement of any one of claims 12 to 15, wherein the cover is formed out of a resilient material.

17. The shape memory alloy arrangement of any one of claims 12 to 16, wherein the shape memory alloy member and the cover are arranged substantially concentrically.

18. The shape memory alloy arrangement of any one of claims 12 to 16, wherein the shape memory alloy member and the cover are arranged substantially coaxially.

19. The shape memory alloy arrangement of any one of claims 12 to 18, wherein the shape memory alloy member has a longitudinal length, the heat conductive material covers an entire external surface of the shape memory alloy member along at least a portion of the longitudinal length and the cover surrounds the heat conductive material and the shape memory alloy member along the portion of the length of the shape memory alloy member covered by the heat conductive material.

20. The shape memory alloy arrangement of any one of the preceding claims, further including means for facilitating the change in temperature of the shape memory alloy member.

21. The shape memory alloy arrangement of claim 20, wherein the means for facilitating the change in temperature of the shape memory alloy member includes means for applying an electrical current to the shape memory alloy member.

22. A shape memory alloy actuator including a shape memory alloy arrangement according to any one of the preceding claims, wherein the shape memory alloy arrangement is configured to be connected to a movable object and to move the object in response to a change in temperature of the shape memory alloy member.
